(19) United States
(12) Patent Application Publication
(10) Pub. No.: US 2025/0122406 A1
(43) Pub. Date: Apr. 17, 2025

(54) COMPOSITION

(71) Applicant: Merck Patent GMGH, Darmstadt (DE)

(72) Inventors: Daishi Yokoyama, Shizuoka (JP); Atsuko Yamamoto, Shizuoka (JP); Kyungmi Choi, Pyeongtaek (KR); Hye-Ryung Park, Suwon-si (KR); Hyun-Jin Yoon, Anyang-si (KR)

(21) Appl. No.: 18/999,284

(22) Filed: Dec. 23, 2024

Related U.S. Application Data
(63) Continuation of application No. PCT/EP2023/067219, filed on Jun. 26, 2023.

(30) Foreign Application Priority Data
Jun. 27, 2022 (EP) 22181297.7

(51) Int. Cl. C09D 183/04; B05D 3/02; C09D 7/63; C09D 7/80

(52) U.S. Cl. CPC C09D 183/04; B05D 3/0254; C09D 7/63; C09D 7/80; B05D 2320/00; B05D 2518/10

(57) ABSTRACT

The present invention relates to a composition comprising i) a polysiloxane and ii) a sulfur containing chemical compound represented by following chemical formula (I) as defined herein

XS—Y (I).

### CROSS REFERENCE TO RELATED APPLICATIONS

This application is a Continuation under 35 USC § 111 (a) of International Patent Application No. PCT/EP2023/065252, filed Jun. 7, 2023, which claims priority to Japanese Patent Application No. JP2022-094713, filed on Jun. 10, 2022. Both applications are hereby incorporated in their entirety.

### FIELD OF THE INVENTION

The present invention relates to a composition comprising at least comprising at least a polysiloxane, preferably relates to a protection layer forming composition, method for fabricating a composition, method of fabricating a layer, a layer, an electronic device, method of using a sulfur containing chemical compound and method of using a composition as a protection layer.

### BACKGROUND ART

US2010 2010/0016488 A1 discloses a process for producing an organosiloxane polymer comprising hydrolyzing tri- and tetraalkoxysilane monomers in a hydrolysis step; and polymerizing said hydrolyzed monomers in a polymerization step by subjecting them to conditions conducive to polymerization to form an organosiloxane polymer; wherein the hydrolysis step is conducted in a reaction medium comprising an organic compound with hydroxy groups. It also discloses use of a composition produced by a process for optical and electrical coatings.

### SUMMARY OF THE INVENTION

However, the inventors newly have found that there are still one or more of considerable problems for which improvement is desired, as listed below:

obtaining a polysiloxane containing composition, preferably being a protection layer forming composition, showing an improved dielectric constant like glass substrate of an electronic device, preferably with lowest haze property; obtaining a layer or cured composition, showing an improved dielectric constant like glass substrate of an electronic device, preferably with lowest haze property; obtaining a polysiloxane containing composition, preferably being a protection layer forming composition, enabling sufficient amount of thiol well dispersed in the composition; obtaining a layer or cured composition, in which sufficient amount of thiol well dispersed in the layer or cured composition; obtaining a polysiloxane containing composition, preferably being a protection layer forming composition, enabling mild or lower temperature process to form a layer or cured composition, smooth coating of polysiloxane containing composition onto any substrate, namely onto PET, CPI, COP or a polarizer.

The inventors aimed to solve one or more of the above-mentioned problems.

Then it is found as claimed, a novel composition, preferably being a protection layer forming composition, comprising at least, essentially consisting of or consisting of:
i) a polysiloxane; and
ii) a sulfur containing chemical compound represented by following chemical formula (I), preferably it is a dielectric constant promoter preferably used for a polysiloxane containing composition.

XS—Y (I)
wherein
X is a hydrogen atom or a non-substituted or substituted alkyl group having 1 to 4 carbon atoms, preferably it is a hydrogen atom; Y is a non-substituted or substituted alkyl group having 1 to 12 carbon atoms, non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, where one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, where one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and where one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.

In another aspect, the present invention relates to a method of fabricating the composition of any one of the preceding claims, comprising at least the step of,
(I^{x}) mixing a polysiloxane; and
a sulfur containing chemical compound represented by following chemical formula (I).

XS—Y (I)

In another aspect, the present invention relates to a composition obtained or obtainable by the method of the present invention.
In another aspect, the present invention relates to a method of fabricating a layer comprising at least, essentially consisting of or consisting of, the following steps;
(I^{Y}) providing the composition of the present invention, preferably onto a substrate, a supporting layer or onto a layer of an electronic device;
(II^{Y}) heating the provided composition to form a layer, preferably to remove a solvent in the composition.

In another aspect, the present invention relates to a layer obtained from the composition of the present invention by curing or obtained by the method of the present invention.

In another aspect, the present invention relates to a layer comprising at least, essentially consisting of or consisting of;
i) a polymer made from a polysiloxane; and
ii) a sulfur containing chemical compound represented by following chemical formula (I).

XS—Y (I)

In another aspect, the present invention relates to an electronic device comprising at least a layer of the present invention.

In another aspect, the present invention further relates to a method of using the sulfur containing chemical compound of chemical formula (I) as a dielectric constant promoter in a polysiloxane containing composition.

In another aspect, the present invention further relates to a method of using of the composition of the present invention as a protection layer forming composition for an electronic device.

Further advantages of the present invention will become evident from the following detailed description.

### Definition of the Terms

In the present specification, symbols, units, abbreviations, and terms have the following meanings unless otherwise specified.

In the present specification, unless otherwise specifically mentioned, the singular form includes the plural form and “one” or “that” means “at least one”. In the present specification, unless otherwise specifically mentioned, an element of a concept can be expressed by a plurality of species, and when the amount (for example, mass % or mol %) is described, it means sum of the plurality of species. “and/or” includes a combination of all elements and also includes single use of the element.

In the present specification, when a numerical range is indicated using “to” or “-”, it includes both endpoints and units thereof are common. For example, 5 to 25 mol % means 5 mol % or more and 25 mol % or less.

In the present specification, the hydrocarbon means one including carbon and hydrogen, and optionally including oxygen or nitrogen. The hydrocarbyl group means a monovalent or divalent or higher valent hydrocarbon. In the present specification, the aliphatic hydrocarbon means a linear, branched or cyclic aliphatic hydrocarbon, and the aliphatic hydrocarbon group means a monovalent or divalent or higher valent aliphatic hydrocarbon. The aromatic hydrocarbon means a hydrocarbon comprising an aromatic ring which may optionally not only comprise an aliphatic hydrocarbon group as a substituent but also be condensed with an alicycle. The aromatic hydrocarbon group means a monovalent or divalent or higher valent aromatic hydrocarbon. Further, the aromatic ring means a hydrocarbon comprising a conjugated unsaturated ring structure, and the alicycle means a hydrocarbon having a ring structure but comprising no conjugated unsaturated ring structure.

In the present specification, the alkyl means a group obtained by removing any one hydrogen from a linear or branched, saturated hydrocarbon and includes a linear alkyl and branched alkyl, and the cycloalkyl means a group obtained by removing one hydrogen from a saturated hydrocarbon comprising a cyclic structure and optionally includes a linear or branched alkyl in the cyclic structure as a side chain.

In the present specification, the aryl means a group obtained by removing any one hydrogen from an aromatic hydrocarbon. The alkylene means a group obtained by removing any two hydrogens from a linear or branched, saturated hydrocarbon. The arylene means a hydrocarbon group obtained by removing any two hydrogens from an aromatic hydrocarbon.

In the present specification, when polymer has a plural types of repeating units, these repeating units copolymerize. These copolymerization are any of alternating copolymerization, random copolymerization, block copolymerization, graft copolymerization, or a mixture of any of these.

In the present specification, Celsius is used as the temperature unit. For example, 20° C., 20 degrees means 20 degrees Celsius.

### DETAILED DESCRIPTION OF THE INVENTION

According to the present invention, in one aspect, the composition, preferably being a protection layer forming composition, comprises at least, essentially consisting of or consisting of;
i) a polysiloxane; and
ii) a sulfur containing chemical compound represented by following chemical formula (I), preferably it is a dielectric constant promoter preferably used for a polysiloxane containing composition.

XS—Y (I)
wherein
X is a hydrogen atom or a non-substituted or substituted alkyl group having 1 to 4 carbon atoms, preferably it is a hydrogen atom; Y is a non-substituted or substituted alkyl group having 1 to 12 carbon atoms, non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, where one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, where one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and where one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.

### Composition

In a preferable embodiment of the present invention, the dielectric constant (εᵣ) of the solid content of the composition is in the range from 3.5 to 7, more preferably it is from 4 to 6.5, even more preferably from 4.5 to 6. Preferably said dielectric constant (εᵣ) of the solid content of the composition is measured by the following method from the view point of realizing high dielectric constant of the composition and an obtained layer.

According to the present invention, said dielectric constant (εᵣ) of the solid content of the composition is measured by the following method.
1) Sample preparation and measurement of dielectric constant Coating said composition on a conductive wafer selected from Al, Si or Mo;
Putting electrodes on the coated composition using Ag or Al by sputtering or vapor deposition to form a sample:
Measuring the dielectric constant of the sample by attaching of pin probers to the surface of the conductive wafer and the top electrode on coated composition respectively.
2) Measurement conditions; The dielectric constant is measured by LCR meter (E4980A, Agilent (Korea)/6440B, Toyo technical (Japan) with applying specific range of frequency (50˜1 MHz) at room temperature and reading the capacitance indicated in the LCR meter. The value of dielectric constant is calculated by next equation, C=KA/d (C≡Capacitance, K=Dielectric constant, A=Effective area of electrode, d=Distance between electrodes).

### ii) Sulfur Containing Chemical Compound

According to the present invention, any publicly available sulfur containing chemical compound represented by the chemical formula (I) or chemical formula (I^{z}) can be used. Preferably any publicly available sulfur containing chemical compound represented by the chemical formula (I) is used. Preferably the molecular weight (Mw) of the sulfur containing chemical compound is 600 or less, preferably 500 or less, more preferably 400 or less, furthermore preferably in the range from 80 to 400, the most preferably from 100 to 210. When the sulfur containing chemical compound represented by the chemical formula (I) is used, preferable molecular weight (Mw) of the sulfur containing chemical compound is 400 or less, more preferably in the range from 80 to 400, furthermore preferably from 100 to 210.

It is believed that above mentioned molecular weight can realize improved dispersity of the sulfur containing chemical compound in a polysiloxane and good compatibility with polysiloxane. And it may lead lower haze value of the composition and a layer obtained from the composition.

In a preferable embodiment of the present invention, the total amount of the sulfur containing chemical compound based on the total amount of the polysilazane in the composition is in the range from 0.01 to 40 wt %, preferably it is in the range from 0.1 to 20 wt %, more preferably from 0.5 to 5.0 wt %.

It is believed that the above mentioned total amount of the sulfur containing chemical compound based on the total amount of the polysiloxane in the composition can realize further improved dispersibility of the sulfur containing chemical compound in the composition and obtained layer with lower haze value of the layer obtained from the composition with optimal high value of the dielectric constant of the composition and the obtained layer like a Glass substrate.

According to the present invention, preferably said sulfur containing chemical compound of formula (I) is represented by following chemical formula (IIa) or (IIb).

X^{a}S—Y^{a}—Z^{a} (IIa)
X^{a} is a hydrogen atom or a non-substituted or substituted alkyl group having 1 to 4 carbon atoms, preferably it is a hydrogen atom;
Y^{a} is a non-substituted or substituted straight alkylene group having 1 to 12 carbon atoms or a non-substituted or substituted branched alkylene group having 3 to 12 carbon atoms, which may be substituted by one or more radicals R^{a}, where one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSH, SO2, NR^{a}, OS, or CONR^{a} and where one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another;
Z^{a} is *—CR^{a1}R^{a2}R^{a3}, where R^{a1}, R^{a2} and R^{a3} are independently each other, a hydrogen atom or a halogen atom selected from Cl, Br, F or I, and at least one of R^{a1}, R^{a2} and R^{a3} is a halogen atom, preferably at least two of R^{a1}, R^{a2} and R^{a3} are halogen atom, more preferably R^{a1}, R^{a2} and R^{a3} are all halogen atom, preferably said halogen atom is Cl or F, more preferably the halogen atom is F.

X^{b}S—Y^{b} (IIb)
X^{b} is a hydrogen atom or a non-substituted or substituted alkyl group having 1 to 4 carbon atoms, preferably it is a hydrogen atom;
Y^{b} is non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, where one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, where one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and where one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.

For examples, 1; 2-mercaptobenzimidazole, 2-mercaptoimidazole, benzene-1,2-dithiol, cyclohexanethiol, 2,2,2-trifluoroethanethiol, 1-Phenethyl-1H-benzo[d]imidazole-2-2thiol, PEMP(Pentaerythritol tetrakis(3-mercaptopropronate)), TMMP(Trimethylolpropane tris(3-mercaptopropionate)), can be used preferably.

In another aspect of the present invention, the invention also relates to a composition, preferably being a protection layer forming composition, comprising at least, essentially consisting of or consisting of;
i) a polysiloxane; and
ii) a sulfur containing chemical compound represented by following chemical formula (I^{z}), preferably it is a dielectric constant promoter preferably used for a polysiloxane containing composition.

(X^{z}S—Y^{z})ₙ-A^{z} (12)
X^{z} is a hydrogen atom or a non-substituted or substituted alkyl group having 1 to 4 carbon atoms, preferably it is a hydrogen atom;
Y^{z} is R^{z}—C═O;
R^{z} is a non-substituted or substituted straight alkylene group having 1 to 5 carbon atoms or a non-substituted or substituted branched alkylene group having 3 to 5 carbon atoms, where one or more non-adjacent CH₂ groups of said alkylene group, may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSH, SO2, NR^{a}, OS, or CONR^{a} and where one or more H atoms may be replaced by D, F, Cl, Br, I, CN or NO₂;
A^{z} is a polyol group selected from pentaerythritol, trimethylolpropane, glycerine, ethylene glycol or propylene, where oxygen atom of each hydroxy group of said polyol group is directly connected to carbon atom of C═O of Y^{z} as —COO— or A^{z} is a nitrogen containing heterocyclic compound selected from 3-membered ring containing 1 to 3 nitrogen atoms, 4-membered ring containing 1 to 4 nitrogen atoms, 5-membered ring containing 1-4 nitrogen atoms, 6-membered ring containing 1-4 nitrogen atoms or 7-membered ring containing 1 to 4 nitrogen atoms as a ring constituting atom, preferably it is an isocyanurate;
n is an integer 1 to 4 and it is identical to the number of functional groups of A^{z} or a molecular charge number of A^{z}.

As the sulfur containing chemical compound represented by chemical formula (I^{z}), Pentaerythritol tetrakis(3-mercaptobutanate), Tris(3-mercaptobutyloxyethyl) isocyanurate, Trimethylolpropane tris(3-mercaptobutyrate), Pentaerythritol Tetra(3-mercaptopropionate) can be used preferably.

### i) Polysiloxane

according to the present invention, any publicly available polysiloxane can be used. Preferably the polysiloxane comprises a repeating unit of chemical formula (I^{a}).

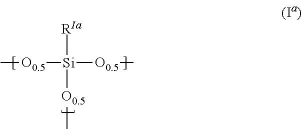

wherein
R^{Ia} is hydrogen, a C₁₋₃₀ (preferably C₁₋₁₀) linear, C₃₋₃₀ (preferably C₃₋₁₀) branched or cyclic, saturated or unsaturated, aliphatic hydrocarbon group or aromatic hydrocarbon group, the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced, or one or more methylene is replaced by oxy, imino or carbonyl, provided that R^{Ia} is neither hydroxy nor alkoxy.

Here, the above-described methylene also includes a terminal methyl.

Further, the above-described “substituted with fluorine, hydroxy or alkoxy” means that a hydrogen atom directly bonded to a carbon atom in an aliphatic hydrocarbon group and aromatic hydrocarbon group is replaced with fluorine, hydroxy or alkoxy. In the present specification, the same applies to other similar descriptions.

In a more preferable embodiment of the present invention, in the repeating unit represented by the formula (I^{a}), R^{Ia} includes, for example, (i) alkyl, such as methyl, ethyl, propyl, butyl, pentyl, hexyl, heptyl, octyl and decyl, (ii) aryl, such as phenyl, tolyl and benzyl, (iii) fluoroalkyl, such as trifluoromethyl, 2,2,2-trifluoroethyl and 3,3,3-trifluoropropyl, (iv) fluoroaryl, (v) cycloalkyl, such as cyclohexyl, (vi) a nitrogen-containing group having an amino or imide structure, such as isocyanate and amino, and (vii) an oxygen-containing group having an epoxy structure, such as glycidyl, or an acryloyl structure or a methacryloyl structure. It is preferably methyl, ethyl, propyl, butyl, pentyl, hexyl and phenyl. The compound wherein R^{Ia} is methyl is preferred, since raw material thereof is easily obtained, its film hardness after curing is high and it has high chemical resistance. Further, the compound wherein R^{Ia} is phenyl is preferred since it increases solubility of the polysiloxane in the solvent and the cured film becomes hardly crackable.

In a preferred embodiment of the present inventions, the polysiloxane used in the present invention may further comprise a repeating unit represented by formula (I^{b}):

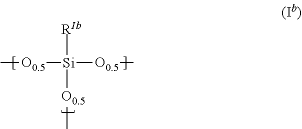

wherein
R^{Ib} is a group obtained by removing plural hydrogen from a nitrogen and/or oxygen-containing cycloaliphatic hydrocarbon compound having amino, imino and/or carbonyl.
In the formula (Ib), R^{Ib} is preferably a group obtained by removing plural hydrogen, preferably two or three hydrogen, from preferably a nitrogen-containing aliphatic hydrocarbon ring having imino and/or carbonyl, more preferably a 5-membered or 6-membered ring containing nitrogen as a member. For example, groups obtained by removing two or three hydrogen from piperidine, pyrrolidine or isocyanurate. R^{Ib} connects Si each other included in plural repeating units.

In a preferable embodiment of the present invention, the polysiloxane used in the present invention may further comprise a repeating unit represented by the formula (I^{c}):

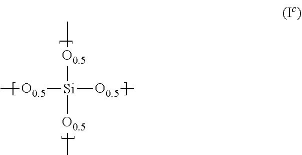

When the mixing ratio of the repeating units represented by the formulae (I^{b}) and (I^{c}) is high, compatibility with solvents and additives decreases, and the film stress increases so that cracks sometimes easily generate. Therefore, it is preferably 40 mol % or less with, more preferably 20 mol % or less, based on the total number of the repeating units of the polysiloxane.

According to the present invention, in some embodiments, the polysiloxane used in the present invention may further comprise a repeating unit represented by the formula (10):

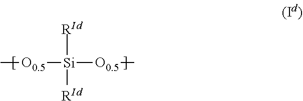

wherein
R^{Id} each independently represents hydrogen, a C₁₋₃₀ (preferably C₁₋₁₀) linear, C₃₋₃₀ (preferably C₃₋₁₀) branched or cyclic, saturated or unsaturated, aliphatic hydrocarbon group or aromatic hydrocarbon group;
the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced or replaced with oxy, imide or carbonyl.

In the repeating unit represented by the formula (I^{d}). R^{Id} includes, for example, (i) alkyl, such as methyl, ethyl, propyl, butyl, pentyl, hexyl, heptyl, octyl and decyl, (ii) aryl, such as phenyl, tolyl and benzyl, (iii) fluoroalkyl, such as trifluoromethyl, 2,2,2-trifluoroethyl and 3,3,3-trifluoropropyl, (iv) fluoroaryl, (v) cycloalkyl, such as cyclohexyl, (vi) a nitrogen-containing group having an amino or imide structure, such as isocyanate and amino, and (vii) an oxygen-containing group having an epoxy structure, such as glycidyl, or an acryloyl structure or a methacryloyl structure. It is preferably methyl, ethyl, propyl, butyl, pentyl, hexyl and phenyl. The compound wherein R^{Id} is methyl is preferred, since raw material thereof is easily obtained, its film hardness after curing is high and it has high chemical resistance. Further, the compound wherein R^{Id} is phenyl is preferred since it increases solubility of the polysiloxane in the solvent and the cured film becomes hardly crackable.

By having the repeating unit of the above formula (I^{d}), it is possible to make the polysiloxane according to the present invention partially of a linear structure.

However, since heat resistance is reduced, it is preferable that portions of linear structure are few. In particular, the repeating unit of the formula (I^{d}) is preferably 30 mol % or less, more preferably 5 mol % or less, based on the total number of the repeating units of the polysiloxane. It is also one aspect of the present invention to have no repeating unit of the formula (I^{d}) (0 mol %).

The polysiloxane used in the present invention may contain two or more types of repeating units. For example, it can contain three types of repeating units having repeating units represented by the formula (Ia) in which R^{Ia} is methyl or phenyl and a repeating unit represented by the formula (I^{c}).

In addition, the polysiloxane used in the composition according to the present invention preferably has silanol. Here, the silanol refers to one in which an OH group is directly bonded to the Si skeleton of polysiloxane and is one in which hydroxy is directly attached to a silicon atom in the polysiloxane comprising repeating units such as the above formulae (I^{a}) to (I^{d}). That is, the silanol is composed by bonding −O0.5H to −O0.5—in the above formulae (I^{a}) to (I^{d}). The content of the silanol in polysiloxane varies depending on the conditions for synthesizing polysiloxane, for example, the mixing ratio of the monomers, the type of the reaction catalyst and the like.

The content of this silanol can be evaluated by quantitative infrared absorption spectrum measurement. The absorption band assigned to silanol (SiOH) appears as an absorption band having a peak in the range of 900±100 cm 1 in the infrared absorption spectrum. When the content of the silanol is high, the intensity of this absorption band increases.

In the present invention, in order to quantitatively evaluate the silanol content, the intensity of the absorption band assigned to Si—O is used as a reference. An absorption band having a peak in the range of 1100±100 cm⁻¹ is adopted as a peak assigned to Si—O. The silanol content can be relatively evaluated by the ratio S2/S1, which is a ratio of the integrated intensity S2 of the absorption band assigned to SiOH to the integrated intensity SI of the absorption band assigned to Si—O. In the present invention, the ratio S2/S1 is preferably 0.003 to 0.15, more preferably 0.01 to 0.10.

The integrated intensity of the absorption band is determined in consideration of noise in the infrared absorption spectrum. In a typical infrared absorption spectrum of polysiloxane, an absorption band assigned to Si—OH having a peak in the range of 900±100 cm⁻¹ and an absorption band assigned to a Si—O having a peak in the range of 1100±100 cm⁻¹ are confirmed. The integrated intensity of these absorption bands can be measured as an area in consideration of a baseline in which noise and the like are considered. Incidentally, there is a possibility that the foot of the absorption band assigned to Si—OH and the foot of the absorption band assigned to Si—O are overlapped; however, in such a case, the wavenumber corresponding to the minimal point between the two absorption bands in the spectrum is set as their boundary. The same applies to the case where the foot of the other absorption band overlaps with the foot of the absorption band assigned to Si—OH or Si—O.

The mass average molecular weight of the polysiloxane used in the present invention is not particularly limited. However, the higher the molecular weight, the more the coating properties tend to be improved. On the other hand, the lower the molecular weight is, the less synthesis conditions are limited, so that the synthesis is easy, and the synthesis of polysiloxane having a remarkably high molecular weight is difficult. For these reasons, the mass average molecular weight of polysiloxane is usually 500 to 25,000, and preferably 1,000 to 20,000 from the viewpoint of solubility in an organic solvent. Here, the mass average molecular weight means a mass average molecular weight in terms of polystyrene, which can be measured by the gel permeation chromatography based on polystyrene.

As stated above, publicly available polysiloxane falls under above definitions can be used preferably for examples like described in WO2021/099236 A1, EP 3717966 B1.

### Solvent

In a preferred embodiment of the present invention, the composition may further comprises a solvent from the view point of improved handling, coating, coating of the composition when string it or when fabricating a layer. Or from the viewpoint of providing solventless composition, the composition contains solvent 5 wt % or less based on the total amount of polysiloxane of the composition, preferably the composition does not contain any solvent.

Preferably said solvent is selected from one or more members of the group consisting of propylene glycol monomethyl ether acetate, propylene glycol monomethyl ether, γ-butyrolactone, propylene glycol diacetate, diethylene glycol monohexyl ether and methyl 3-methoxypropionate, methyl isobutyl ketone, methyl ethyl ketone, more preferably it is γ-butyrolactone, propylene glycol monomethyl ether acetate or a mixture of γ-butyrolactone and propylene glycol monomethyl ether acetate.

It is believed that above selected solvents have good compatibility with the composition, boiling points, viscosity and/or vapor pressure, realizing better handling of the composition, suitable for lower temperature fabrication of the layer and/or realizing an easy fabrication.

In a preferred embodiment of the present invention, the total amount of the solvent based on the total amount of polysiloxane is 0 to 300 wt %. When the composition contains a solvent, preferably from 0.1 to 150 wt %, more preferably from 50 to 90 wt %.

### Additives

In some embodiments of the present invention, optionally, the composition may further comprise one or more of additives. Such additive may be selected from one or more members of the group consisting of, for examples, surfactants, adhesion promoter, silane coupling agent, thermal acid generators, thermal base generators, crosslinkable monomers and polymerization initiators. Publicly available ones can be used preferably, like described in EP 3717966 A1 or WO 2021/099236 A1. Since said additive is not mandatory for this invention, the amount of the additive in the composition or in the layer based on the total amount of polysiloxane is preferably 5 wt % or less, more preferably 1 wt % or less. The composition and/or a layer obtained from the composition may not contain any said additives.

In another aspect, present invention further relates to a method of fabricating the composition of the present invention, comprising at least, essentially consisting of or consisting of; the step of,
(I^{x}) mixing a polysiloxane; and
a sulfur containing chemical compound represented by following chemical formula (I) or chemical formula (I^{z}), preferably a sulfur containing chemical compound is represented by following chemical formula (I) optionally with a solvent and/or an another additive.

XS—Y (I)

The detailed explanation of the sulfur containing chemical compound and polysiloxane, including preferable amounts, are indicated above in the section of ii) Sulfur containing chemical compound, and i) polysiloxane.

In another aspect, present invention further relates to a composition obtained or obtainable by the method of fabricating the composition described above.

In another aspect, present invention further relates to a method of fabricating a layer comprising at least, essentially consisting of or consisting of the following steps;
(I^{Y}) providing the composition of the present invention, preferably onto a substrate, a supporting layer or onto a layer of an electronic device;
(II^{Y}) heating the provided composition to form a layer, preferably to remove a solvent in the composition, preferably said heating is conducted at the temperature in the range from 60 to 140° C., more preferably in the range from 80 to 130° C.
(III^{Y}) optionally irradiating the provided composition with ultraviolet (UV) light to cure.
According to the present invention, said UV light is a light having peak light wavelength in the range from 250-450 nm.

In another aspect, present invention further relates to a layer obtained from the composition of the present invention by curing or obtained by the method of fabricating a layer explained above. Preferably said layer is a protection layer of an electric device. Preferably said curing is a heat curing and/or UV light curing.

In another aspect, present invention further relates to a layer comprising at least, essentially consisting of or consisting of;
i) a polymer made from a polysiloxane; and
ii) a sulfur containing chemical compound represented by following chemical formula (I) or chemical formula (I^{z}), preferably a sulfur containing chemical compound is represented by following chemical formula (I)

XS—Y (I)
The detailed explanation of the sulfur containing chemical compound and polysiloxane, including the preferable amounts, are indicated above in the section of ii) Sulfur containing chemical compound, and i) polysiloxane.

In a preferred embodiment of the present invention, the dielectric constant (εᵣ) of the solid content of the layer is in the range from 3.5 to 10, more preferably it is from 3.6 to 8, even more preferably from 4 to 7, furthermore preferably from 4.5 to 6.

It is believed that above mentioned the dielectric constant (εᵣ) of the solid content of the layer realizes improved touch sensitivity of the layer like glass substrate when it is used as a protection layer of an device, namely electronic device, such as OLED, LCD.

The dielectric constant of the layer is measured as described above in the section of Composition.

In a preferred embodiment of the present invention, the Haze value of the layer is less than 100%, preferably it is in the range from 0.01 to 10%, more preferably from 0.1 to 5%.

According to the present invention, said Haze value is measured at room temperature in air using a haze measurement system with an integrating sphere (NDH-7000, Nippon Denshoku, Japan, Light source White LED 3 W, wavelength range 380˜780 nm). The sample thickness is between 2 μm and 700 μm. Particularly it is 700 μm.
Schematics of the integrating sphere for transmittance and haze measurement, the total transmittance (T_{T}) T_{T}=T_{P}+T_{D}, the haze (H)H=T_{D}/T_{T}.

The parallel transmittance (T_{P}) is determined by measuring the light intensity at a position opposite to that of the sample in the sphere, and the total transmittance (T_{T}), including the diffracted light transmittance (T_{P}) and T_{P}, is obtained by measuring the light passing through the sample, using the equation T_{T}=T_{P}+T_{D}. The degree of light scattering in the sample, i.e., the haze (H), is defined as H=T_{D}/T_{T}. The transmittance and haze is measured.

In another aspect, present invention further relates to an electronic device comprising at least a layer of the present invention, preferably said electronic device comprises a light modulating or a light emitting layer, preferably said layer is placed onto the outermost surface of the electronic device. More preferably it is an light extraction side (viewing side) of the electronic device. Preferably said electronic device does not comprise a cover glass substrate and the layer is used instead of the cover glass substrate to realize a cover glass free electronic device with having good touch sensitivity, preferably with lower haze value.

In another aspect, present invention further relates to a method of using the sulfur containing chemical compound of chemical formula (I) as a dielectric constant promoter in a polysiloxane containing composition.

In another aspect, present invention further relates to a method of using of the composition of the present invention as a protection layer forming composition for an electronic device, preferably using the composition instead of an upper glass substrate of said electronic device.

Preferable embodiments
1. A composition, preferably being a protection layer forming composition, comprising at least, essentially consisting of or consisting of;
i) a polysiloxane; and
ii) a sulfur containing chemical compound represented by following chemical formula (I) or chemical formula (I^{z}), preferably a sulfur containing chemical compound is represented by following chemical formula (I), preferably it is a dielectric constant promoter preferably used for a polysiloxane containing composition

XS—Y (I)
wherein
X is a hydrogen atom or a non-substituted or substituted alkyl group having 1 to 4 carbon atoms, preferably it is a hydrogen atom; Y is a non-substituted or substituted alkyl group having 1 to 12 carbon atoms, non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, where one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, where one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and where one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.
2. The composition of embodiment 1, wherein the molecular weight (Mw) of the sulfur containing chemical compound is 600 or less, preferably 500 or less, more preferably 400 or less, furthermore preferably in the range from 80 to 400, the most preferably from 100 to 210.
3. The composition of embodiment 1 or 2, wherein the total amount of the sulfur containing chemical compound based on the total amount of the polysilazane in the composition is in the range from 0.01 to 40 wt %, preferably it is in the range from 0.1 to 20 wt %, more preferably from 0.5 to 5.0 wt %.
4. The composition of any one of the preceding embodiments, wherein the dielectric constant (εᵣ) of the solid content of the composition is in the range from 3.5 to 7, more preferably it is from 4 to 6.5, even more preferably from 4.5 to 6. Preferably said dielectric constant (εᵣ) of the solid content of the composition is measured by the following method.
1) Sample preparation and measurement of dielectric constant Coating said composition on a conductive wafer selected from Al, Si or Mo;
Putting electrodes on the coated composition using Ag or Al by sputtering or vapor deposition to form a sample:
Measuring the dielectric constant of the sample by attaching of pin probers to the surface of the conductive wafer and the top electrode on coated composition respectively.
2) Measurement conditions; The dielectric constant is measured by LCR meter (E4980A, Agilent (Korea)/6440B, Toyo technical (Japan) with applying specific range of frequency (50˜1 MHZ) at room temperature and reading the capacitance indicated in the LCR meter. The value of dielectric constant is calculated by next equation, C=KA/d (C≡Capacitance, K=Dielectric constant, A=Effective area of electrode, d=Distance between electrodes)
5. The composition of any one of the preceding embodiments, said sulfur containing chemical compound (I) is represented by following chemical formula (IIa) or (IIb).

X^{a}S—Y^{a}—Z^{a} (IIa)
X^{a} is a hydrogen atom or a non-substituted or substituted alkyl group having 1 to 4 carbon atoms, preferably it is a hydrogen atom;
Y^{a} is a non-substituted or substituted straight alkylene group having 1 to 12 carbon atoms or a non-substituted or substituted branched alkylene group having 3 to 12 carbon atoms, which may be substituted by one or more radicals R^{a}, where one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSH, SO2, NR^{a}, OS, or CONR^{a} and where one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another;
Z^{a} is *—CR^{a1}R^{a2}R^{a3}, where R^{a1}, R^{a2} and R^{a3} are independently each other, a hydrogen atom or a halogen atom selected from Cl, Br, F or I, and at least one of R^{a1}, R^{a2} and R^{a3} is a halogen atom, preferably at least two of R^{a1}, R^{a2} and R^{a3} are halogen atom, more preferably R^{a1}, R^{a2} and R^{a3} are all halogen atom, preferably said halogen atom is Cl or F, more preferably the halogen atom is F.

X^{b}S—Y^{b} (IIb)
X^{b} is a hydrogen atom or a non-substituted or substituted alkyl group having 1 to 4 carbon atoms, preferably it is a hydrogen atom;
Y^{b} is non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, where one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, where one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and where one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.
6. The composition of any one of the preceding embodiments, wherein the polysiloxane comprises a repeating unit of chemical formula (I^{a}).

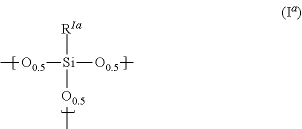

wherein
R^{Ia} is hydrogen, a C₁₋₃₀ (preferably C₁₋₁₀) linear, C₃₋₃₀ (preferably C₃₋₁₀) branched or cyclic, saturated or unsaturated, aliphatic hydrocarbon group or aromatic hydrocarbon group, the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced, or one or more methylene is replaced by oxy, imino or carbonyl, provided that R^{Ia} is neither hydroxy nor alkoxy.
7. The composition of any one of the preceding embodiments, wherein the polysiloxane comprises a repeating unit of chemical formula (I^{b}).

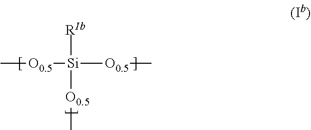

wherein
R^{Ib} is a group obtained by removing plural hydrogen from a nitrogen and/or oxygen-containing cycloaliphatic hydrocarbon compound having amino, imino and/or carbonyl.
R^{Ib} is preferably a group obtained by removing plural hydrogen, preferably two or three hydrogen, from preferably a nitrogen-containing aliphatic hydrocarbon ring having imino and/or carbonyl, more preferably a 5-membered or 6-membered ring containing nitrogen as a member. For example, groups obtained by removing two or three hydrogen from piperidine, pyrrolidine or isocyanurate. R^{Ib} connects Si each other included in plural repeating units.
8. The composition of any one of the preceding embodiments, wherein the polysiloxane comprises a repeating unit of chemical formula (I^{c}).

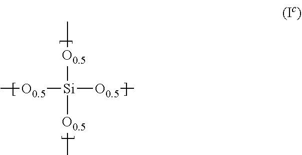

9. The composition of any one of the preceding embodiments, wherein the polysiloxane comprises a repeating unit of chemical formula (I^{d}).

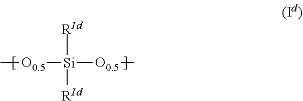

wherein
R^{Id} each independently represents hydrogen, a C₁₋₃₀ (preferably C₁₋₁₀) linear, C₃₋₃₀ (preferably C₃₋₁₀) branched or cyclic, saturated or unsaturated, aliphatic hydrocarbon group or aromatic hydrocarbon group;
the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced or replaced with oxy, imide or carbonyl.
10. The composition of any one of the preceding embodiments, the composition further comprises an additive.
11. The composition of any one of the preceding embodiments, further comprises a solvent. Preferably said solvent is selected from one or more members of the group consisting of propylene glycol monomethyl ether acetate, propylene glycol monomethyl ether, γ-butyrolactone, propylene glycol diacetate, diethylene glycol monohexyl ether and methyl 3-methoxypropionate, methyl isobutyl ketone, methyl ethyl ketone, more preferably it is γ-butyrolactone, propylene glycol monomethyl ether acetate or a mixture of γ-butyrolactone and propylene glycol monomethyl ether acetate.
12. A method of fabricating the composition of any one of the preceding embodiments, comprising at least the step of,
(I^{x}) mixing a polysiloxane; and
a sulfur containing chemical compound represented by following chemical formula (I) or chemical formula (I^{z}), preferably a sulfur containing chemical compound is represented by following chemical formula (I)

XS—Y (I)
wherein
X is a hydrogen atom or a non-substituted or substituted alkyl group having 1 to 4 carbon atoms, preferably it is a hydrogen atom;
Y is a non-substituted or substituted alkyl group having 1 to 12 carbon atoms, non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, where one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, where one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and where one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.
13. A composition obtained or obtainable by the method of embodiment 12.
14. A method of fabricating a layer comprising at least the following steps;
(I^{Y}) providing the composition of any one of embodiments 1 to 11 and 13, preferably onto a substrate, a supporting layer or onto a layer of an electronic device; preferably such substrate is selected from a glass substrate, a plastic substrate, or a polarizer.
(II^{Y}) heating the provided composition to form a layer, preferably to remove a solvent in the composition, preferably said heating is conducted at the temperature in the range from 60 to 140° C., more preferably in the range from 80 to 130° C.
15. A layer obtained from the composition of any one of the embodiments 1 to 13 by curing or obtained by the method of embodiment 14. Preferably said layer is a protection layer of an electric device. Preferably said curing is a heat curing.
16. A layer comprising at least;
i) a polymer made from a polysiloxane; and
ii) a sulfur containing chemical compound represented by following chemical formula (I) or chemical formula (I^{z}), preferably a sulfur containing chemical compound is represented by following chemical formula (I)

XS—Y (I)
wherein
X is a hydrogen atom or a non-substituted or substituted alkyl group having 1 to 4 carbon atoms, preferably it is a hydrogen atom; Y is a non-substituted or substituted alkyl group having 1 to 12 carbon atoms, non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, where one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, where one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and where one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.
17. The layer of embodiment 15 or 16, wherein the dielectric constant (εᵣ) of the solid content of the layer is in the range from 3.5 to 10, more preferably it is from 3.6 to 8, even more preferably from 4 to 7, furthermore preferably from 4.5 to 6.
18. The layer of any one of the embodiments 15 to 17, wherein the Haze value of the layer is less than 100%, preferably it is in the range from 0.01 to 10%, more preferably from 0.1 to 5%, wherein said Haze value is measured at room temperature in air using a haze measurement system with an integrating sphere (NDH-7000, Nippon Denshoku, Japan, Light source White LED 3 W, wavelength range 380˜780 nm).
   Schematics of the integrating sphere for transmittance and haze measurement, the total transmittance (T_{T}) T_{T}=T_{P}+T_{D}, the haze (H) H=T_{D}/T_{T}.
The parallel transmittance (T_{P}) is determined by measuring the light intensity at a position opposite to that of the sample in the sphere, and the total transmittance (T_{T}), including the diffracted light transmittance (T_{D}) and T_{P}, is obtained by measuring the light passing through the sample, using the equation T_{T}=T_{P}+T_{D}. The degree of light scattering in the sample, i.e., the haze (H), is defined as H=T_{D}/T_{T}. The transmittance and haze is measured.
19. An electronic device comprising at least a layer of any one of embodiments 15 to 18, preferably said electronic device comprises a light modulating or a light emitting layer, preferably said layer is placed onto the outermost surface of the electronic device. More preferably it is an light extraction side (viewing side) of the electronic device.
20. Method of using the sulfur containing chemical compound of chemical formula (I) or chemical formula (I^{z}) as a dielectric constant promoter in a polysiloxane containing composition.
21. Method of using of the composition of any one of the embodiments 1 to 11 and 13, as a protection layer forming composition for an electronic device, preferably using the composition instead of an upper glass substrate of said electronic device.

### Technical Effects of the Invention

The present invention provides one or more of the following technical effects:
obtaining a polysiloxane containing composition, preferably being a protection layer forming composition, showing an improved dielectric constant like glass substrate of an electronic device, preferably with lowest haze property; obtaining a layer or cured composition, showing an improved dielectric constant like glass substrate of an electronic device, preferably with lowest haze property; obtaining a polysiloxane containing composition, preferably being a protection layer forming composition, enabling sufficient amount of thiol well dispersed in the composition; obtaining a layer or cured composition, in which sufficient amount of thiol well dispersed in the layer or cured composition; obtaining a polysiloxane containing composition, preferably being a protection layer forming composition, enabling mild or lower temperature process to form a layer or cured composition, smooth coating of polysiloxane containing composition onto any substrate, namely onto PET, CPI, COP or a polarizer.

### WORKING EXAMPLES

The working examples 1-10 below provide descriptions of the present invention, as well as an in-detail description of their fabrication. However, the present invention is not limited to these working examples.

### Working Example 1

Mixture sample preparation Polysiloxane polymer from Merck represented by following chemical formula is mixed with 1w % or 5w % 1; 2-mercaptobenzimidazole as the thiol containing compound based on the total amount of polysiloxane in the presence of the mixture of propyleneglycol monomethyl ether acetate and Gamma-Butyrolactone (total weight of said siloxane polymer and the thiol containing compound:solvent mixture=3:7). After mixing above compounds, it is coated onto an Al deposited silicone wafer by spin coating each separately to obtain samples (sample 1-1 containing 1% 1; 2-mercaptobenzimidazole and sample 1-2 containing 5% 1; 2-mercaptobenzimidazole). Then, the solvent mixture is evaporated at 120° C. of curing process to obtain samples 1-1 (1%) and 1-2 (5%).

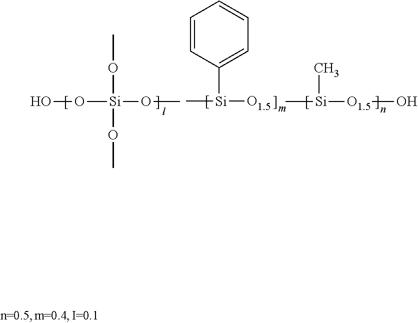

### Working Examples 2 to 9: Mixture Sample Preparation

Working examples 2 to 9 are performed in the same manner as described in working example 1 except for that the thiol containing compound listed below is used instead of 1; 2-mercaptobenzimidazole. Then 1% thiol containing compound samples (sample 2-1, 3-1, 4-1, 5-1, 6-1, 7-1, 8-1, 9-1) and 5% thiol containing compound samples (sample 2-2, 3-2, 4-2, 5-2, 6-2, 7-2, 8-2, 9-2) are obtained in each working examples.
Thiol containing compounds used in the working examples 1 to 9
Comparative example 1: no thiol containing compound is used
Working Example 1:1; 2-mercaptobenzimidazole
Working Example 2:2-mercaptoimidazole
Working Example 3: benzene-1,2-dithiol
Working Example 4: cyclohexanethiol
Working Example 5:2,2,2-trifluoroethanethiol
Working Example 6: Pentaerythritol tetrakis(3-mercaptobutanate)
Working Example 7: Tris(3-mercaptobutyloxyethyl) isocyanurate
Working Example 8: Trimethylolpropane tris(3-mercaptobutyrate)
Working Example 9: Pentaerythritol Tetra(3-mercaptopropionate)

Another thiol containing compounds such as 1-Phenethyl-1H-benzo[d]imidazole-2-2thiol could also be used preferably.

### Comparative Example 1: Reference Sample Preparation

Reference sample is prepared in the same manner as described in working example 1 except for that no thiol containing compound is added/mixed with the siloxane polymer. Then reference sample is obtained.

### Working Example 10

measurement of dielectric constant of the samples from working examples 1 to 6 and comparative example 1

The Haze values of the samples from working examples 1 to 6 and comparative example 1 are measured each independently at room temperature in air using a haze measurement system with an integrating sphere (NDH-7000, Nippon Denshoku, Japan, Light source White LED 3 W, wavelength range 380˜780 nm). The sample thickness is between 2 μm and 700 μm. Particularly it is 700 μm. Schematics of the integrating sphere for transmittance and haze measurement, the total transmittance (T_{T}) T_{T}=T_{P}+T_{D}, the haze (H) H=T_{D}/T_{T}.

The parallel transmittance (T_{P}) is determined by measuring the light intensity at a position opposite to that of the sample in the sphere, and the total transmittance (T_{T}), including the diffracted light transmittance (T_{D}) and T_{P}, is obtained by measuring the light passing through the sample, using the equation T_{T}=T_{P}+T_{D}. The degree of light scattering in the sample, i.e., the haze (H), is defined as H=T_{D}/T_{T}. The transmittance and haze is measured.

Following table 1 show the results of the measurements.

TABLE 1

| | | Wt. % of the | |
|---|---|---|---|
| | | thiol | |
| Sample | Thiol containing | containing | dielectric |
| name | compound | compound | constant |
| Reference | No compound | 0 | 3.40 |
| Sample 1-1 | 1; 2-mercaptobenzimidazole | 1 | 4.58 |
| Sample 1-2 | 1; 2-mercaptobenzimidazole | 5 | 4.54 |
| Sample 2-1 | 2-mercaptoimidazole | 1 | 4.69 |
| Sample 2-2 | 2-mercaptoimidazole | 5 | 4.51 |
| Sample 3-1 | benzene-1,2-dithiol | 1 | 4.71 |
| Sample 3-2 | benzene-1,2-dithiol | 5 | 4.76 |
| Sample 4-1 | cyclohexanethiol | 1 | 4.67 |
| Sample 4-2 | cyclohexanethiol | 5 | 4.65 |
| Sample 5-1 | 2,2,2-trifluoroethanethiol | 1 | 4.96 |
| Sample 5-2 | 2,2,2-trifluoroethanethiol | 5 | 5.05 |
| Sample 6-1 | Pentaerythritol | 1 | 3.71 |
| | tetrakis(3- | | |
| | mercaptobutanate) | | |
| Sample 6-2 | Pentaerythritol | 5 | 4.35 |
| | tetrakis(3- | | |
| | mercaptobutanate) | | |

As shown above table 1, thiol containing compounds, preferably the thiol containing compounds used in samples 1 to 5, increase the dielectric constant of the polysiloxane composition dramatically. And it is believed that it can help touch sensitivity for glass free electronic devices such as touch glass free OLED concept.

1. A composition, preferably being a protection layer forming composition, comprising at least;
i) a polysiloxane; and
ii) a sulfur containing chemical compound represented by following chemical formula (I):
XS—Y (I)
wherein
X is a hydrogen atom or a non-substituted or substituted alkyl group having 1 to 4 carbon atoms;
Y is a non-substituted or substituted alkyl group having 1 to 12 carbon atoms, non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, wherein one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, wherein one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and wherein one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.

2. The composition of claim 1, wherein the molecular weight (Mw) of the sulfur containing chemical compound is 600 or less.

3. The composition of claim 1, wherein the total amount of the sulfur containing chemical compound based on the total amount of the polysilazane in the composition is in the range from 0.01 to 40 wt %.

4. The composition of claim 1, wherein the dielectric constant (εᵣ) of the solid content of the composition is in the range from 3.5 to 7.

5. The composition of claim 1, wherein said sulfur containing chemical compound is represented by following chemical formula (IIa) or (IIb).
X^{a}S—Y^{a}—Z^{a} (IIa)
X^{b}S—Y^{b} (IIb)
wherein
X^{a} is a hydrogen atom or a non-substituted or substituted alkyl group having 1 to 4 carbon atoms;
Y^{a} is a non-substituted or substituted straight alkylene group having 1 to 12 carbon atoms or a non-substituted or substituted branched alkylene group having 3 to 12 carbon atoms, which may be substituted by one or more radicals R^{a}, wherein one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSH, SO2, NR^{a}, OS, or CONR^{a} and wherein one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another;
Z^{a} is *—CR^{a1}R^{a2}R^{a3}, where R^{a1}, R^{a2} and R^{a3} are independently each other, a hydrogen atom or a halogen atom selected from Cl, Br, F or I, and at least one of R^{a1}, R^{a2} and R^{a3} is a halogen atom.

6. The composition of claim 1, wherein the polysiloxane comprises a repeating unit of chemical formula (I^{a}) 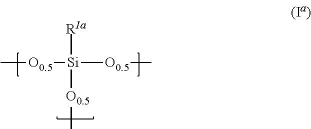
wherein
R^{Ia} is hydrogen, a C₁₋₃₀ (preferably C₁₋₁₀) linear, C₃₋₃₀ (preferably C₃₋₁₀) branched or cyclic, saturated or unsaturated, aliphatic hydrocarbon group or aromatic hydrocarbon group, the aliphatic hydrocarbon group and the aromatic hydrocarbon group are each unsubstituted or substituted with fluorine, hydroxy or alkoxy, and
in the aliphatic hydrocarbon group and the aromatic hydrocarbon group, methylene is not replaced, or one or more methylene is replaced by oxy, imino or carbonyl, provided that R^{Ia} is neither hydroxy nor alkoxy.

7. The composition of claim 1, wherein the polysiloxane comprises a repeating unit of chemical formula (I^{b}) 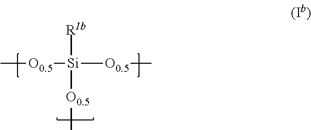
wherein
R^{Ib} is a group obtained by removing plural hydrogen from a nitrogen and/or oxygen-containing cycloaliphatic hydrocarbon compound having amino, imino and/or carbonyl.

8. The composition of claim 1, further comprising a solvent.

9. A method of fabricating the composition of claim 1, comprising at least the step of,
(I^{x}) mixing a polysiloxane; and
a sulfur containing chemical compound represented by following chemical formula (I).
XS—Y (I)
wherein
X is a hydrogen atom or a non-substituted or substituted alkyl group having 1 to 4 carbon atoms, preferably it is a hydrogen atom;
Y is a non-substituted or substituted alkyl group having 1 to 12 carbon atoms, non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, wherein one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, wherein one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and wherein one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.

10. A method of fabricating a layer comprising at least the following steps;
(I^{Y}) providing the composition of claim 1; and
(II^{Y}) heating the provided composition to form a layer.

11. A layer obtained from the method of claim 10.

12. A layer comprising at least;
i) a polymer made from a polysiloxane; and
ii) a sulfur containing chemical compound represented by following chemical formula (I).
XS—Y (I)
wherein
X is a hydrogen atom or a non-substituted or substituted alkyl group having 1 to 4 carbon atoms, preferably it is a hydrogen atom;
Y is a non-substituted or substituted alkyl group having 1 to 12 carbon atoms, non-substituted or substituted cyclic alkyl group having 3 to 22 carbon atoms, non-substituted or substituted aryl group having 3 to 22 carbon atoms, non-substituted or substituted alkyl-aryl group having 4 to 22 carbon atoms, which may be substituted by one or more radicals R^{a}, wherein one or more non-adjacent CH₂ groups of said alkyl group, cyclic alkyl group, aryl group and/or said alkyl-aryl group may be, independently of each other, replaced by R^{a}C≡CR^{a}, C≡C, Si(R^{a})₂, Ge(R^{a})₂, Sn(R^{a})₂, C═O, C═S, C═Se, C═NR^{a}, P(═O)(R^{a}), SO, CSR^{a}, SO2, NR^{a}, OS, or CONR^{a}, wherein one or more non-adjacent CH groups of said aryl group and/or said alkyl-aryl group may be, independently of each other, replaced by SiR^{a}, GeR^{a}, SnR^{a}, CSR^{a}, SO2, NR^{a}, O, S, SO, or CONR^{a}, and wherein one or more H atoms may be replaced by D, F, Cl, Br, I, CN or NO₂;
R^{a} is at each occurrence, identically or differently, H, D or an alkyl group having 1 to 10 carbon atoms, cyclic alkyl group having 3 to 10 carbon atoms, an aryl group having 3 to 10 carbon atoms, aryl-alkyl group having 4 to 10 carbon atoms or a hetero aryl group having 3 to 10 carbon atoms, wherein H atoms may be replaced by D, F, Cl, Br, I;
two or more adjacent substituents R^{a} here may also form a mono- or polycyclic, aliphatic, aromatic or heteroaromatic ring system with one another.

13. The layer of claim 11, wherein the dielectric constant (εᵣ) of the solid content of the layer is in the range from 3.5 to 10.

14. The layer of claim 11, wherein the Haze value of the layer is less than 100%.

15. An electronic device comprising at least a layer of claim 11.
